(19) United States
(12) Patent Application Publication
(10) Pub. No.: US 2008/0253384 A1
(43) Pub. Date: Oct. 16, 2008

(54) COMMUNICATION CONTROL METHOD, RELAYING METHOD AND RELAYING DEVICE

(75) Inventors: Masaaki Noro, Kawasaki (JP); Noriyuki Fukuyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 11/926,752

(22) Filed: Oct. 29, 2007

Related U.S. Application Data
(62) Division of application No. 09/993,498, filed on Nov. 27, 2001.

(30) Foreign Application Priority Data
Aug. 30, 2001 (JP) 2001-261282

(51) Int. Cl. H04L 12/56

(52) U.S. Cl. 370/401

(57) ABSTRACT

Method and device for heightening communications security. Gateway 3 receives packet P1 from caller terminal 1a, and creates and transmits to receiver terminal 1b packet P2, in which destination IP address, source IP address, destination port, source port, and session ID for packet P1 are rewritten. Gateway 3 also receives packet P3 from receiver terminal 1b, and creates and transmits to caller terminal 1a packet P4, in which destination IP address, source IP address, destination port, source port, and session ID for packet P3 are rewritten. Because communications between every terminal are identifiable according to session ID, a plurality of communications through the same port may be supported, which is favorable security-wise.

### BACKGROUND OF THE INVENTION

1. Technical Field

The present invention relates to communications control systems between computers on the Internet and computers connected to the Internet insulated by firewalls.

2. Description of Related Art

Take for example Internet telephony using, e.g., Internet telephone terminals on the Internet, and Internet telephone terminals connected to the Internet insulated by firewalls. Port numbers are used in Internet telephony to distinguish among a plurality of voice communications. Therefore, to let voice data from an Internet telephony application pass, the considerably broadband RTP/UDP (Real-time Transport Protocol/User Datagram Protocol) port number must be set for passing the firewall.

In transmitting/receiving voice and animation, UDP (User Datagram Protocol) is generally used. In a situation where a plurality of communications are carried out using UDP, it is necessary either: 1) to allocate a port to every communication; or 2) to assign a data-allotting application to a single port and enter in the data section information for distinguishing communications, and with allotting software to interpret-by derivation from information such as IP address and port number of the packet-sending source- and distribute the data to a program that actually processes the data.

In Internet telephony via firewalls, communications are carried out according to the VoIP protocol, and voice data is transmitted/received using UDP. In a situation where, for example, a telephone company is to offer Internet telephony services, if 100 calls are to be supported simultaneously on a computer terminal at the telephone company, 200 port numbers will be necessary. This is because two ports, receiving and sending, are required for one call with UDP. Because there are many security problems with this, however, in reality it is hard to adopt.

On the other hand, using an exchange device to let voice data pass without opening a hole in the firewall is conceivable. The firewall may be avoided if an exchange device is utilized, since the Internet and Intranet connect via the exchange device. Put differently, the firewall can be avoided by installing a non-IP section on the firewall section. Nevertheless, in addition to the high cost of the exchange device, delays arise with this method in the data exchange between the Internet and the exchange device, and between the Intranet and the exchange device. Therefore, this method, by which two exchanges are necessary between the two ends of the communications line, is undesirable owing to a severe worsening in voice quality.

### SUMMARY OF THE INVENTION

An object of the present invention is to provide communications control technology for combining sufficient security compatibly with sufficient data quality in telephonic communications.

The present invention provides a communications control method utilized in a communications system in which a first communications terminal T1, a second communications terminal T2, and a relaying terminal that relays communications by the two terminals are connected via a network. The communications control method includes:

a first determination step, prior to the first communications terminal T1 and the second communications terminal T2 carrying out communications via the relaying terminal, of the first communications terminal T1 determining first communications identification information S1 for identifying intercommunications between its terminal and the relaying terminal;

a second determination step, prior to the first communications terminal T1 and the second communications terminal T2 carrying out communications via the relaying terminal, of the relaying terminal determining second communications identification information S2 for identifying intercommunications between its terminal and the first communications terminal T1;

a third determination step, prior to the first communications terminal T1 and the second communications terminal T2 carrying out communications via the relaying terminal of the relaying terminal determining third communications identification information S3 for identifying intercommunications between its terminal and the second communications terminal T2;

a fourth determination step, prior to the first communications terminal T1 and the second communications terminal T2 carrying out communications via the relaying terminal, of the second communications terminal T2 determining fourth communications identification information S4 for identifying intercommunications between its terminal and the relaying terminal;

a first communications step of the first communications terminal T1 and the relaying terminal carrying out transmission and reception of first data containing the first communications identification information S1 and the second communications identification information S2;

a second communications step of the second communications terminal T2 and the relaying terminal carrying out transmission and reception of second data containing the third communications identification information S3 and the fourth communications identification information S4;

a first relaying step, when the relaying terminal is to transmit to the second communications terminal T2 first data received from the first communications terminal T1, of rewriting within the first data the first communications identification information S1 and the second communications identification information S2 as the third communications identification information S3 and the fourth communications identification information S4; and

a second relaying step, when the relaying terminal is to transmit to the first communications terminal T1 data received from the second communications terminal T2, of rewriting within the data the third communications identification information S3 and the fourth communications identification information S4 as the first communications identification information S1 and the second communications identification information S2.

This communications control method is utilized in communications among for example a first communications terminal T1 on the Internet, a second communications terminal T2 on an Intranet, and a gateway that connects the Internet and the Intranet. The first communications terminal T1 and the gateway, and the second communications terminal T2 and the gateway mutually report communications identification information (referred to as “session IDs” hereinafter) among one another, and transmit and receive session IDs for their terminals and partner terminals together with data. This enables, while a plurality of communications are supported through a single port, each communication to be identified by session ID.

A second aspect of the present invention provides a relaying method utilized by a relaying terminal that is connected via a network with a first communications terminal T1 and a second communications terminal T2, and that relays communications between the two terminals. The relaying method includes:

a first determination step of determining second communications identification information S2 identifying a communication carried out with the first communications terminal T1 for relaying communications between the first communications terminal T1 and the second communications terminal T2;

a second determination step of determining third communications identification information S3 for identifying a communication carried out with the second communications terminal T2 for relaying communications between the first communications terminal T1 and the second communications terminal T2;

a first communications step of carrying out with the first communications terminal T1 transmission and reception of data containing the second communications identification information S2;

a second communications step of carrying out with the second communications terminal T2 transmission and reception of data containing the third communications identification information S3;

a first relaying step of rewriting, when data received from the first communications terminal T1 is to be transmitted to the second communications terminal T2, the second communications identification information S2 within the data as the third communications identification information S3; and

a second relaying step of rewriting, when data received from the second communications terminal T2 is to be transmitted to the first communications terminal T1, the third communications identification S3 within the data as the second communications identification information S2.

This method is applicable to gateways connected between the Internet and an Intranet. With this method, utilizing communications identification information (referred to as “session IDs” hereinafter), a relaying device identifies communications with other terminals. Relaying of communications from the first communications terminal T1 and second communications terminal T2 is carried out as follows. When data containing session ID “S2” is received from the first communications terminal T1, the session ID in the data is rewritten as “S3” and the data is transmitted to the second communications terminal T2. Conversely, when data containing session ID “S3” is received from the second communications terminal T2, the session ID in the data is rewritten as “S2,” and the data is transmitted to the first communications terminal T1.

A third aspect of the present invention provides the relaying method set forth in the second aspect. The relaying methods further includes:

a first acquisition step of acquiring first communications identification information S1 identifying a communication that the first communications terminal T1 carries out with the relaying terminal in order to communicate with the second communications terminal T2;

a second acquisition step of acquiring fourth communications identification information S4 identifying a communication that the second communications terminal T2 carries out with the relaying terminal in order to communicate with the first communications terminal T1; wherein

the first communications step carries out with the first communications terminal T1 transmission and reception of data further containing the first communications identification information S1,

the second communications step carries out with second communications terminal T2 transmission and reception of data further containing the fourth communications identification information S4,

the first relaying step, when data received from the first communications terminal T1 is to be transmitted to the second communications terminal T2, rewrites within the data the first communications identification information S1 and the second communications identification information S2 as the third communications identification information S3 and the fourth communications identification information S4, and

the second relaying step, when data received from the second communications terminal T2 is to be transmitted to the first communications terminal T1, rewrites within the data the third communications identification information S3 and the fourth communications identification information S4 as the first communications identification information S1 and the second communications identification information S2.

Under this method, every terminal possesses session IDs that identify communications between other terminals and their terminals. Communications between terminals are specified by combining the two terminals' session IDs. This method is also applicable to multi-stage relaying.

A fourth aspect of the present invention provides the relaying method set forth in the second aspect. The relaying method further includes a table-preparation step of preparing a session table; wherein

within a single record the session table:
stores the first communications identification information S1 and second communications identification information S2 correlatively with a communications address for the first communications terminal T1, and
stores the third communications identification information S3 and the fourth communications identification information S4 correlatively with a communications address for the second communications terminal T2.

Specifically, the relaying terminal prepares in the session table entries for relaying communications by the first communications terminal T1 and second communications terminal T2. S1, S2 S3, S4, and IP addresses for the first communications terminal T1 and second communications terminal T2 are written into the entries.

A fifth aspect of the present invention provides the relaying method set forth in the fourth aspect. The relaying method further includes:

a termination receiving step of accepting notification that communications between the first communications terminal T1 and the second communications terminal T2 have terminated; and

a deletion step of deleting from the session table a record corresponding to communications between the first communications terminal T1 and the second communications terminal T2.

When the relaying terminal accepts the communication termination notice, it deletes from the session table the entries pertaining to the communications.

A sixth aspect of the present invention provides the relaying method set forth in the second aspect, wherein the relaying terminal is further connected with a computer terminal connected via the network to the first communications terminal T1 and the second communications terminal T2. The relaying method further includes:

a communications-request receiving step of receiving from the computer terminal a report indicating that there has been a request from the first communications terminal T1 for communication with the second communications terminal T2;

a first notification step of reporting the second communications identification information S2 to the first communications terminal T1 via the computer terminal; and

a second notification step of reporting the third communications identification information S3 to the second communications terminal T2 via the computer terminal.

The relaying terminal in this method is further connected with a separate computer (gatekeeper). Communication-request generation and session ID notification are carried out via the gatekeeper. Session ID notification from the first communications terminal T1 and second communications terminal T2 is received via the gatekeeper also.

A seventh aspect of the present invention provides the relaying method set forth in the sixth aspect. The relaying method further includes:

a third acquisition step of acquiring from the computer first communications identification information S1 identifying a communication that the first communications terminal T1 carries out with the relaying terminal in order to communicate with the second communications terminal T2;

a fourth acquisition step of acquiring from the computer fourth communications identification information S4 identifying a communication that the second communications terminal T2 carries out with the relaying terminal in order to communicate with the first communications terminal T1; wherein the first communications step carries out with the first communications terminal T1 transmission and reception of data further containing the first communications identification information S1,

the second communications step carries out with second communications terminal T2 transmission and reception of data further containing the fourth communications identification information S4,

the first relaying step, when data received from the first communications terminal T1 is to be transmitted to the second communications terminal T2, rewrites within the data the first communications identification information S1 and the second communications identification information S2 as the third communications identification information S3 and the fourth communications identification information S4, and

the second relaying step, when data received from the second communications terminal T2 is to be transmitted to the first communications terminal T1, rewrites within the data the third communications identification information S3 and the fourth communications identification information S4 as the first communications identification information S1 and the second communications identification information S2.

The relaying terminal acquires session ID “S1” for first communications terminal T1, and session ID “S4” for second communications terminal T2 via the aforementioned gatekeeper. After acquisition of the session IDS, relaying of communications by the two terminals T1, T2 takes place, without the gatekeeper intermediating.

An eighth aspect of the present invention provides the relaying method set forth in the sixth aspect. The relaying method further includes:

an alive-confirmation step of transmitting to and receiving from the computer terminal at fixed time intervals TM1 alive information signifying one's terminal is alive; and

a suspend step of suspending relaying of communications between the first communications terminal T1 and the second communications terminal T2 if the alive information has not been received from the computer terminal though a fixed time TM2 or more has elapsed.

The relaying terminal immediately suspends relaying operations if the gatekeeper (aforementioned computer terminal) is down.

A ninth aspect of the present invention provides a relaying device connected via a network with a first communications terminal T1 and a second communications terminal T2, for relaying communications between the two terminals. The relaying device comprises:

a first determination means for determining second communications identification information S2 identifying a communication carried out with the first communications terminal T1 for relaying communications between the first communications terminal T1 and the second communications terminal T2;

a second determination means for determining third communications identification information S3 identifying a communication carried out with the second communications terminal T2 for relaying communications between the first communications terminal T1 and the second communications terminal T2;

a first communications means for carrying out with the first communications terminal T1 transmission and reception of data containing the second communications identification information S2;

a second communications means for carrying out with the second communications terminal T2 transmission and reception of data containing the third communications identification information S3;

a first relaying means for rewriting, when data received from the first communications terminal T1 is to be transmitted to the second communications terminal T2, the second communications identification information S2 within the data as the third communications identification information S3; and

a second relaying means for rewriting, when data received from the second communications terminal T2 is to be transmitted to the first communications terminal T1, the third communications identification S3 within the data as the second communications identification information S2.

A tenth aspect of the present invention provides a relaying computer product utilized by a computer connected via a network with a first communications terminal T1 and a second communications terminal T2, for relaying communications between the two terminals, the relaying computer product for making the computer function as:

a first determination means for determining second communications identification information S2 identifying a communication carried out with the first communications terminal T1 for relaying communications between the first communications terminal T1 and the second communications terminal T2;

a second determination means for determining third communications identification information S3 identifying a communication carried out with the second communications terminal T2 for relaying communications between the first communications terminal T1 and the second communications terminal T2;

a first communications means for carrying out with the first communications terminal T1 transmission and reception of data containing the second communications identification information S2;

a second communications means for carrying out with the second communications terminal T2 transmission and reception of data containing the third communications identification information S3;

a first relaying means for rewriting, when data received from the first communications terminal T1 is to be transmitted to the second communications terminal T2, the second communications identification information S2 within the data as the third communications identification information S3; and

a second relaying means for rewriting, when data received from the second communications terminal T2 is to be transmitted to the first communications terminal T1, the third communications identification S3 within the data as the second communications identification information S2.

An eleventh aspect of the present invention provides a computer-readable recording medium on which is recorded a relaying program utilized by a relaying terminal that is connected via a network with a first communications terminal T1 and a second communications terminal T2, and that relays communications between the two terminals, the computer-readable recording medium on which is recorded a relaying program for executing:

a first determination step of determining second communications identification information S2 identifying a communication carried out with the first communications terminal T1 for relaying communications between the first communications terminal T1 and the second communications terminal T2;

a second determination step of determining third communications identification information S3 for identifying a communication carried out with the second communications terminal T2 for relaying communications by the first communications terminal T1 and the second communications terminal T2;

a first communications step of carrying out with the first communications terminal T1 transmission and reception of data containing the second communications identification information S2;

a second communications step of carrying out with the second communications terminal T2 transmission and reception of data containing the third communications identification information S3;

a first relaying step of rewriting, when data received from the first communications terminal T1 is to be transmitted to the second communications terminal T2, the second communications identification information S2 within the data as the third communications identification information S3; and

a second relaying step of rewriting, when data received from the second communications terminal T2 is to be transmitted to the first communications terminal T1, the third communications identification S3 within the data as the second communications identification information S2.

Herein, flexible disks, hard disks, semiconductor memory, CD-ROMs, DVDs, magneto-optical disks (MOs) and other recording media for computer reading/writing may be cited.

A twelfth aspect of the present invention provides a communications control method utilized by a computer connected via a network to a first communications terminal T1, a second communications terminal T2 and a relaying terminal that relays communications between the two terminals. The communications control method includes:

a communication-request acceptance step of accepting from the first communications terminal T1 a request for communication with the second communications terminal T2;

a request notification step of notifying the second communications terminal T2 of the communication request;

a first reporting step of receiving from the first communications terminal T1 and reporting to the relaying terminal first communications identification information S1 identifying a communication that the first communications terminal T1 carries out with the relaying terminal;

a second reporting step of notifying the relaying terminal of the communications request, and receiving from the relaying terminal and reporting to the first communications terminal T1 second communications identification information S2 for identifying a communication that the relaying terminal carries out with the first communications terminal T1;

a third reporting step of notifying the relaying terminal of the communications request, and receiving from the relaying terminal and reporting to the second communications terminal T2 third communications identification information S3 for identifying a communication that the relaying terminal carries out with the second communications terminal T2; and

a fourth reporting step of receiving from the second communications terminal T2 and reporting to the relaying terminal fourth communications identification information S4 identifying a communication that the second communications terminal T2 carries out with the relaying terminal.

This method is applicable to gatekeepers connected between the Internet and an Intranet.

A thirteenth aspect of the present invention provides the communications control method set forth in the twelfth aspect, further including a table-preparation step of preparing a session table; wherein

within a single record the session table:
stores the first communications identification information S1 and second communications identification information S2 correlatively with a communications address for the first communications terminal T1, and
stores the third communications identification information S3 and the fourth communications identification information S4 correlatively with a communications address for the second communications terminal T2.

Specifically, the gatekeeper (aforementioned computer) prepares in the session table entries for relaying communications by the first communications terminal T1 and second communications terminal T2. S1, S2, S3, S4, and IP addresses for the first communications terminal T1 and second communications terminal T2 are written into the entries.

A fourteenth aspect of the present invention provides the communications control method set forth in the thirteenth aspect. The communication control method further includes:

a termination receiving step of accepting notification that communications between the first communications terminal T1 and the second communications terminal Second communications terminal T2 have terminated; and

a deletion step of deleting from the session table records corresponding to communications between the first communications terminal T1 and the second communications terminal T2.

When the gatekeeper accepts the communication termination notice from the first communications terminal T1 or the second communications terminal T2, it deletes from the session table the entries pertaining to those communications.

A fifteenth aspect of the present invention provides the communications control method set forth in the twelfth aspect. The communications control method further includes:

an alive-recognition step of transmitting to and receiving from the computer terminal at fixed time intervals TM1 alive information signifying one's terminal is alive;

a termination reporting step of transmitting a communications termination notice to the first communications terminal T1, the second communications terminal T2, and the relaying terminal if the alive information has not been received from the computer terminal though a fixed time TM2 or more has elapsed; and

cut-off step after transmission of the communications termination notice, of breaking the connection with the first communications terminal T1, the second communications terminal T2, and the relaying terminal.

A sixteenth aspect of the present invention provides a communications control device connected via a network to a first communications terminal T1, a second communications terminal T2, and a relaying terminal that relays communications between the two terminals. The communications control device comprises:

a communication-request acceptance means for accepting from the first communications terminal T1 a request for communication with the second communications terminal T2;

a request notification means for notifying the second communications terminal T2 of the communication request;

a first reporting means for receiving from the first communications terminal T1 and reporting to the relaying is terminal first communications identification information S1 identifying a communication that the first communications terminal T1 carries out with the relaying terminal;

a second reporting means for notifying the relaying terminal of the communications request, and receiving from the relaying terminal and reporting to the first communications terminal T1 second communications identification information S2 for identifying a communication that the relaying terminal carries out with the first communications terminal T1;

a third reporting means for notifying the relaying terminal of the communications requests and receiving from the relaying terminal and reporting to the second communications terminal T2 third communications identification information S3 for identifying a communication that the relaying terminal carries out with the second communications terminal T2; and

a fourth reporting means for receiving from the second communications terminal T2 and reporting to the relaying terminal fourth communications identification information S4 identifying a communication that the second communications terminal T2 carries out with the relaying terminal.

A seventeenth aspect of the present invention provides a communications control computer product utilized by a computer connected via a network to a first communications terminal T1, a second communications terminal T2, and a relaying terminal that relays communications between the two terminals, the communications control computer product for making the computer function as:

a communication-request acceptance means for accepting from the first communications terminal T1 a request for communication with the second communications terminal T2;

a request notification means for notifying the second communications terminal T2 of the communication request;

a first reporting means for receiving from the first communications terminal T1 and reporting to the relaying terminal first communications identification information S1 identifying a communication that the first communications terminal T1 carries out with the relaying terminal;

a second reporting means for notifying the relaying terminal of the communications request, and receiving from the relaying terminal and reporting to the first communications terminal T1 second communications identification information S2 for identifying a communication that the relaying terminal carries out with the first communications terminal T1;

a third reporting means for notifying the relaying terminal of the communications request, and receiving from the relaying terminal and reporting to the second communications terminal T2 third communications identification information S3 for identifying a communication that the relaying terminal carries out with the second communications terminal T2; and

a fourth reporting means for receiving from the second communications terminal T2 and reporting to the relaying terminal fourth communications identification information S4 identifying a communication that the second communications terminal T2 carries out with the relaying terminal.

An eighteenth aspect of the present invention provides a computer-readable recording medium on which is recorded a communications control program utilized by a computer connected via a network to a first communications terminal T1, a second communications terminal T2, and a relaying terminal that relays communications between the two terminals, the computer-readable recording medium on which is recorded a communications control program for executing:

a communication-request acceptance step of accepting from the first communications terminal T1 a request for communication with the second communications terminal T2;

a request notification step of notifying the second communications terminal T2 of the communication request;

a first reporting step of receiving from the first communications terminal T1 and reporting to the relaying terminal first communications identification information S1 identifying a communication that the first communications terminal T1 carries out with the relaying terminal;

a second reporting step of notifying the relaying terminal of the communications request, and receiving from the relaying terminal and reporting to the first communications terminal T1 second communications identification information S2 for identifying a communication that the relaying terminal carries out with the first communications terminal T1;

a third reporting step of notifying the relaying terminal of the communications request, and receiving from the relaying terminal and reporting to the second communications terminal T2 third communications identification information S3 for identifying a communication that the relaying terminal carries out with the second communications terminal T2; and

a fourth reporting step of receiving from the second communications terminal T2 and reporting to the relaying terminal fourth communications identification information S4 identifying a communication that the second communications terminal T2 carries out with the relaying terminal.

Herein, flexible disks, hard disks, semiconductor memory, CD-ROMs, DVDs, magneto-optical disks (MOs) and other recording media for computer reading/writing may be cited.

A nineteenth aspect of the present invention provides a communications control method utilized by a first communications terminal T1 connectable via a network with a second communications terminal T2. The communications control method includes:

a reporting step of reporting to the second communications terminal T2 first communications identification information S1 identifying communications between the second communications terminal T2 and the first communications terminal T1;

a receiving step of receiving from the second communications terminal T2 second communications identification information S2 that the second communications terminal T2 uses for identifying communication with the first communications terminal T1; and

a communications step of communicating with the second communications terminal T2 by carrying out transmission and reception of data containing the first communications identification information S1 and second communications identification information S2.

This method is applicable to the first and second communications terminals T1, T2, the relaying terminal (gateway) in the foregoing first invention, and the computer (gatekeeper) in the foregoing sixth invention. Though the terminals connected through the network are multi-stage connected, neighboring terminal associates report mutual communications sessions to each other prior to the start of communications, and identify communications by combining the mutual communications sessions.

A twentieth aspect of the present invention provides a first communications terminal T1 connectable via a network with a second communications terminal T2. The first communications terminal comprises:

a reporting means for reporting to the second communications terminal T2 first communications identification information S1 identifying communications between the second communications terminal T2 and the first communications terminal T1;

a receiving means for receiving from the second communications terminal T2 second communications identification information S2 that the second communications terminal T2 uses for identifying communication with the first communications terminal T1; and

a communications means for communicating with the second communications terminal T2 by carrying out transmission and reception of data containing the first communications identification information S1 and second communications identification information S2.

A twenty-first aspect of the present invention provides a communications control computer product making a computer function as a first communications terminal T1 connectable via a network with a second communications terminal T2, the communications control computer product further for making the computer function as:

a reporting means for reporting to the second communications terminal T2 first communications identification information S1 identifying communications between the second communications terminal T2 and the first communications terminal T1;

a receiving means for receiving from the second communications terminal T2 second communications identification information S2 that the second communications terminal T2 uses for identifying communication with the first communications terminal T1; and

a communications means for communicating with the second communications terminal T2 by carrying out transmission and reception of data containing the first communications identification information S1 and second communications identification information S2.

A twenty-second aspect of the present invention provides a computer-readable recording medium on which is recorded a communications control program for executing a communications control method utilized by a first communications terminal T1 connectable via a network with a second communications terminal T2, the computer-readable recording medium on which is recorded a communications control program for executing:

a reporting step of reporting to the second communications terminal T2 first communications identification information S1 identifying communications between the second communications terminal T2 and the first communications terminal T1;

a receiving step of receiving from the second communications terminal T2 second communications identification information S2 that the second communications terminal T2 uses for identifying communication with the first communications terminal T1; and

a communications step of communicating with the second communications terminal T2 by carrying out transmission and reception of data containing the first communications identification information S1 and second communications identification information S2.

Herein, flexible disks, hard disks, semiconductor memory, CD-ROMs, DVDS, magneto-optical disks (MOs) and other recording media for computer reading/writing may be cited.

A twenty-third aspect of the present invention provides a communications method for when, via a secure host defending against wrongful access from without, internal terminal devices connected to a network on the inside of the secure host and external terminal devices connected to a network on the outside carry out voice communications. The communications method is characterized by:

accepting by way of the secure host, from outside the secure host, a call request from an external terminal device to a connectable internal terminal device, or accepting by way of the secure host, from inside the secure host, a call request from an internal terminal device to a connectable external terminal device;

when a call between the external terminal device and the internal terminal device is established, reporting to the two terminal devices a path readied in advance for transmitting and receiving voice data, and communications identification information for distinguishing what is voice data between the terminal devices, and meanwhile storing terminal-device information identifying the two terminal devices, correlatively with the communications identification information reported to the two terminal devices;

when the secure host has received form the external terminal device or the internal terminal device voice data containing the communications identification information, specifying, from the terminal-device information stored correlatively with the communications identification information, a communications-destination terminal device for the voice data, and sending out received voice data to the specified terminal device.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is an overall configurational diagram of a communications control system having to do with a first embodied example of the present invention;

FIG. 2 is an explanatory diagram of a relay routine that the gateway carries out;

FIG. 3A is a First session table (caller terminal);

FIG. 3B is a second session table (receiver terminal);

FIG. 3C is a third session table (gateway);

FIG. 4 is an explanatory diagram illustrating flow in a routine for calling;

FIG. 5 is an explanatory diagram illustrating flow in a routine for terminating communications;

FIG. 6 is an overall configurational diagram of communications control system having to do with a second embodied example; and

FIG. 7 is an overall configurational diagram of communications control system having to do with a third embodied example.

### DETAILED DESCRIPTION OF THE PREFERRED EMBODIMENTS

### First Embodied Example

To facilitate illustration, in the following explanation will be made taking voice-communications control on the Internet in accordance with TCP/IP (Transmission Control Protocol/Internet Protocol) as an example.

### Configuration

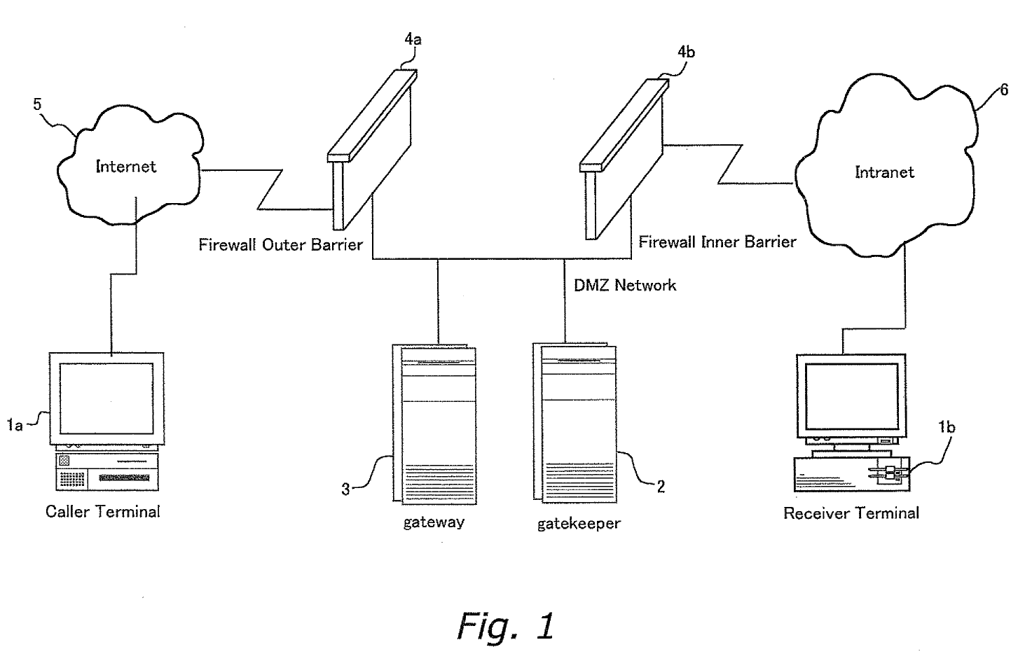

FIG. 1 is a communications control system having to do with a first embodied example of the present invention. Caller terminal 1a on the Internet 5 and receiver terminal 1b on an Intranet 6 are connected via VoIP gatekeeper 2 (gatekeeper 2 hereinafter) and VoIP gateway 3 (gateway 3 hereinafter) in this communications control system. The gatekeeper 2 and gateway 3 are disposed on a DMZ (Demilitarized Zone) network. Here, the DMZ network is utilized for disposing servers such as, ordinarily, Www servers and mail servers for external/public services. Devices on the DMZ network and the Intranet 6 are ordinarily protected by two defense means, firewalls 4a, 4b. The gatekeeper 2 administers voice communications on the DMZ network, and the gateway 3 is used to transfer voice packets.

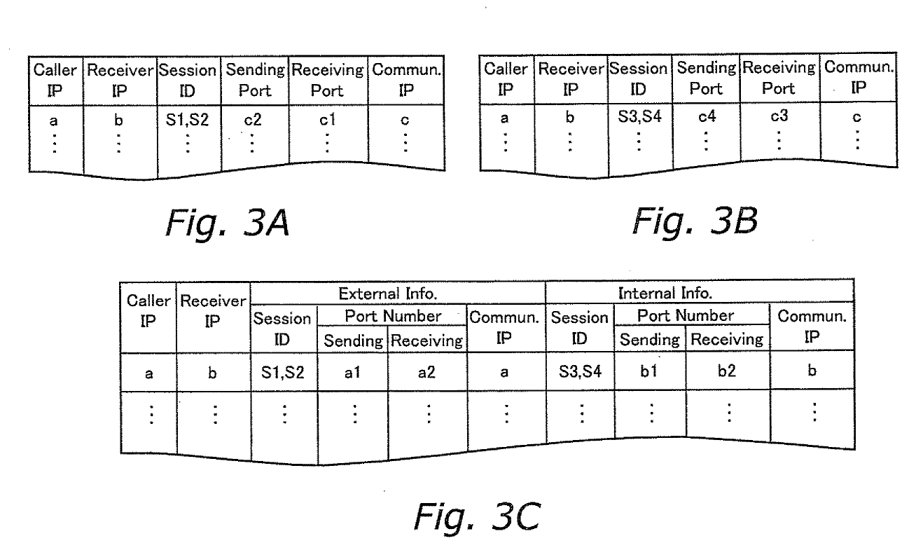

The caller terminal 1a and the receiver terminal 1b have not-shown voice input means and voice output means, and are communications terminals for carrying out voice communications based on VoIP (Voice-over Internet Protocol). The caller terminal 1a and receiver terminal 1b, prior to initiating communications with another terminal, determine a session ID that specifies direct communications with that terminal, and report this to the given communications partner. Further, the caller terminal 1a and the receiver terminal 1b receive from the gatekeeper 2, and temporarily store, a session ID used for specifying communications by the given communications partner with their terminals. The session IDs are stored in a first session table (FIG. 3(a)) and a second session table (FIG. 3(b)), respectively. These tables will be described later. Furthermore, the caller terminal 1a and the receiver terminal 1b annex session IDs, for their terminals and the direct communications partner, to each voice packet, which they send. The created session IDs should be produced within each device so as not to be duplicates; and may be created, for example, based on the communications addresses for the direct communications partner and their terminals, or else created using random-number generation means.

The gatekeeper 2 negotiates with the gateway 3 before the start of voice communications to determine information required for the voice data to pass through the firewall. Herein, the gateway 3 determines a session ID that identities the voice telephone calls between the caller terminal 1a and the receiver terminal 1b, and a port number that the gateway 3 uses for sending or receiving the voice data. Here, whether it is the gateway 3 or the gatekeeper 2 that makes the session ID determination does not matter, but in the present embodied example, the gatekeeper 2 does so. The created session IDs should be produced within each device so as not to be duplicates; and may be created, for example, based on the communications addresses for the direct communications partner and their terminals, or else created using random-number generation means.

Further, the gatekeeper 2 prepares a fourth session table and herein stores information necessary for the gateway 3 to relay communications between the caller terminal 1a and the receiver terminal 1b. Details of the fourth session table will be described later.

The gateway 3 acquires the information necessary to relay communications between the caller terminal 1a and the receiver terminal 1b from the gatekeeper 2. The gateway 3 also records the given acquired information in a third session table. The information stored in the third session table is similar to the information that the gatekeeper 2 has stored in the fourth session table, and the details will be described later. The gateway 3 relays communications between the caller terminal 1a and the receiver terminal 1b based on this third session table.

Further, when the gateway 3 gets a telephone call-ended notification from the gatekeeper 2, it deletes the corresponding communications entries in the third session table.

### Relay Routine

### (1) Premises

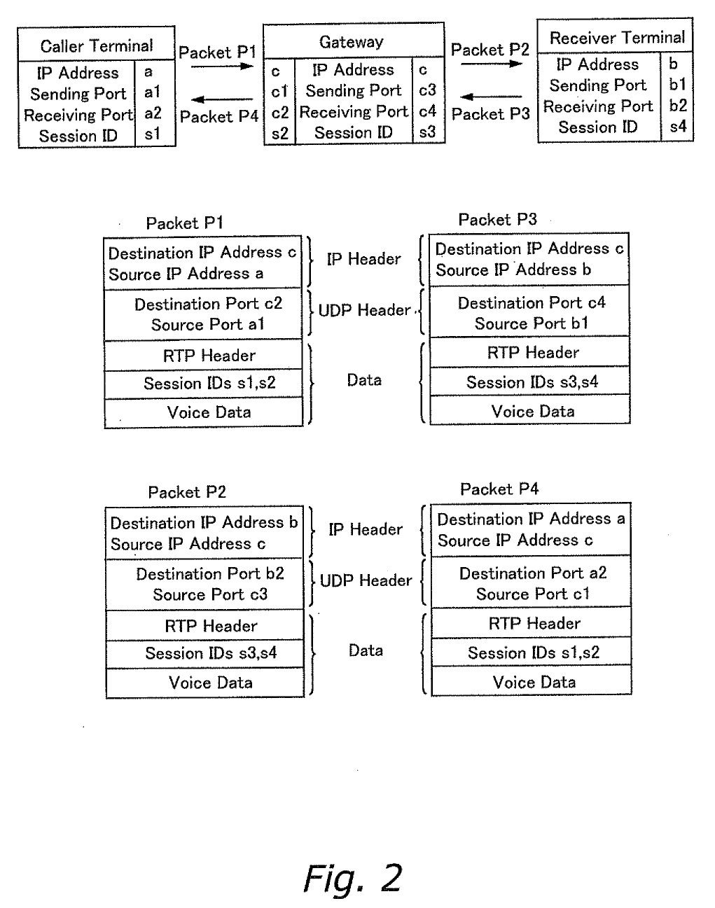

FIG. 2 is an explanatory diagram of a relay routine that the gateway 3 carries out. A relay routine using voice packets in a voice stream process according to RTP/UDP is illustrated in the diagram. The IP addresses, sending ports, receiving ports, and session IDs that the relay routine requires for each terminal are as follows. Herein, “sending ports” are the numbers of the ports through which the terminals send packets. “Receiving ports” are the numbers of the ports through which the terminals receive packets.

(1-1) Caller Terminal 1a

IP address (a): Communications address for caller terminal 1a;
Sending port (a1): Port number caller terminal 1a uses in sending packets;
Receiving port (a2): Port number caller terminal 1a uses in receiving packets;
Session ID (s1): Identification number specifying communications caller terminal 1a carries out with gateway 3 for communicating with receiver terminal 1b.

(1-2) Receiver Terminal 1b

IP address (b): Communications address for receiver terminal 1b;
Sending port (b1): Port number receiver terminal 1b uses in sending packets;
Receiving port (b2): Port number receiver terminal 1b uses in receiving packets;
Session ID (s4): Identification number specifying communications receiver terminal 1b carries out with gateway 3 for communicating with caller terminal 1a.

(1-3) Gateway 3

IP address (c): Communications address for gateway 3;
Sending port (c1): Port number gateway 3 uses for sending packets outside the firewall (“external sending-port number” hereinafter);
Receiving port (c2): Port number gateway 3 uses for receiving packets from outside the firewall (“external receiving-port number” hereinafter);
Session ID (s2): Identification number for specifying communications gateway 3 carries out with caller terminal 1a for relaying communications between caller terminal 1a and receiver terminal 1b (“outside session ID” hereinafter).
Sending port (c3): Port number gateway 3 uses for sending packets inside the firewall (“internal sending-port number” hereinafter);
Receiving port (c4): Port number gateway 3 uses for receiving packets from inside the firewall (“internal receiving-port number” hereinafter);
Session ID (s3): Identification number for specifying communications gateway 3 carries out with receiver terminal 1b for relaying communications between caller terminal 1a and receiver terminal 1b (“inside session ID” hereinafter).

### (2) Session Tables

FIG. 3 is a conceptual explanatory diagram of first, second and third session tables for the caller terminal 1a, the receiver terminal 1b and the gateway 3. FIG. 3A is the first session table, which the caller terminal 1a retains. FIG. 3B is the second session table, which the receiver terminal 1b retains. Referring to the first and second session tables, both the terminals 1a, 1b perform packet transmission and reception. In a singe record both the tables store “caller IP,” which is the IP address of caller terminal 1a, “receiver IP,” which is the IP address of the receiver terminal 1b, “session ID,” “sending port,” “receiving port,” and “communications IP.”

The “communications IP” herein is the IP address of the partner terminal with which each terminal communicates directly. In this example, because the gateway 3 becomes the direct communications partner for the caller terminal 1a and the receiver terminal 1b together, the communications IP is “c.” The “session ID” signifies both the session ID for their terminals and the session ID for the direct communications partner. The “sending port” signifies the direct-communication partners sending-port number. The “receiving port” signifies the direct-communication partner's receiving-port number.

For example, the external sending-port number “c1” and the external receiving-port number “c2” for the gateway 3, which is the direct-communications partner for caller terminal 1a, are stored respectively as “receiving port” and “sending port” in the first session table. Likewise, the internal sending-port number “c3” and the internal receiving-port number “c4” for the gateway 3, which is the direct-communications partner for receiver terminal 1b, are stored respectively as “receiving port” and “sending port” in the second session table.

FIG. 3C is an explanatory diagram of the third session table, which the gateway 3 retains. Because the fourth session table, which the gatekeeper 2 retains, is also similar to the third session table, the third session table is explained herein. “Caller IP address,” “receiver IP address,” and “external information” pertaining to terminals outside the firewalls 4 and “internal information” pertaining to terminals inside, are stored in the third session table. The “caller IP address” and the “receiver IP address” are likewise as with the first and second session tables.

The external information for the gateway 3 contains “external session IDs,” “sending-port numbers” for outside terminals, “receiving-port numbers” for outside terminals, and “communications IP” addresses for direct-communications partner terminals that are outside the firewalls 4. “Internal session IDs,” “sending-port numbers” for inside terminals, “receiving-port numbers” for inside terminals, and “communications IP” addresses for direct-communications partner terminals that are inside the firewalls 4, are included as the “internal information.”

Referring to this session table, the gateway 3 performs the relay routine set forth in the following.

### (3) Relay Routine Details

The relay routine in the gateway 3, in which this information is utilized, will be explained next. The gateway 3 receives a packet P1 from the caller terminal 1a, and creates and transmits to the receiver terminal 1b a packet P2 in which a portion of the packet P1 information is rewritten. Likewise, the gateway 3 receives a packet P3 from the receiver terminal 1b, and creates and transmits to the caller terminal 1a a packet P4 in which a portion of the packet P3 information is rewritten. Packets P1, P2, P3, P4, and packet rewriting are detailed below.

(3-1) Packet P1, Transmitted from Caller Terminal 1a to Gateway 3

Caller terminal 1a creates packet P1 based on the first session table, and transmits it to the receiver terminal 1b. The following information is contained in packet P1.

—Information Contained in Packet P1—
IP-header destination IP address: IP address “c” for gateway 3
IP-header source IP address: IP address “a” for its terminal 1a
UDP-header destination port: gateway 3 external receiving-port number “c2”
UDP-header source port: sending-port number “a1” for its terminal 1a
Data: session IDs “s1” and “s2,” as well as inputted voice data

Having received packet P1, the gateway 3 recognizes, from the session IDs “s1” and “s2” contained in the data segment of the packet P1, that it is a communication between its terminal and the caller terminal 1a. Strictly speaking, the gateway 3 recognizes from the given session IDS that the packet P1 is a communication between its terminal and the caller terminal 1a that is a portion of the communication between caller terminal 1a and receiver terminal 1b. The gateway 3 thereafter searches the third session table, on the session IDs as keys, and reads out the internal information for the records hit. Based on the read-out information, the gateway 3 creates packet P2 out of packet P1, and transmits it to the receiver terminal 1b.

(3-2) Packet P2, Transmitted from Gateway 3 to Receiver Terminal 1b

Having received packet P1, the gateway 3 creates packet P2 by rewriting, based on the third session table, the destination IP address, source IP address, destination port, source port and session ID in the packet P1. The following information is contained in packet P2.

—Information Contained in Packet P2—
IP-header destination IP address: IP address “b” for receiver terminal 1b
IP-header source IP address: IP address “c” for its terminal 3
UDP-header destination port: receiving-port number “b2” for receiver terminal 1b
UDP-header source port: internal sending-port number “c3” for its terminal 3
Data: session IDs “s3” and “s4,” as well as voice data in P1

Having received packet P2, the receiver terminal 1b recognizes, from the session IDs “s3” and “s4” contained in the data segment of the packet P2, that it is a communication between its terminal and the gateway 3. Strictly speaking, the receiver terminal 1b searches the second session table on the given session IDs as keys and recognizes that it is data from the caller terminal 1a, relayed by the gateway 3.

(3-3) Packet P3, Transmitted from Receiver Terminal 1b to Gateway 3

The receiver terminal 1b creates and transmits to gateway 3 packet P3, which contains input voice data. The following information is contained in packet P3.

—Information Contained in Packet P3—
IP-header destination IP address: IP address “c” for gateway 3
IP-header source IP address: IP address “b” for its terminal 1b
UDP-header destination port: internal receiving-port number “c4” for gateway 3
UDP-header source port: sending-port number “b1” for its terminal 1b
Data: session IDs “s3” and “s4,” as well as voice data

Having received packet P3, the gateway 3 recognizes, from the session IDs “s3” and “s4” contained in the data segment of the packet P3, that it is a communication between its terminal and the receiver terminal 1b. Strictly speaking, the gateway 3 searches the third session table with the session IDs as keys and recognizes that it is a packet from the receiver terminal 1b addressed to the caller terminal 1a. The gateway 3 thereafter reads out the external information for the records hit as searching results. Based on the read-out information, the gateway 3 creates packet P4 out of packet P3, and transmits it to the caller terminal 1a.

(3-4) Packet P4, Transmitted from Gateway 3 to Caller Terminal 1a

The caller terminal 1a receives packet P4 from gateway 3. The following information is contained in packet P4.

—Information Contained in Packet P4—
IP-header destination IP address: IP address “a” for caller terminal 1a
IP-header source IP address: IP address “c” for its terminal 3
UDP-header destination port: receiving-port number “a2” for caller terminal 1a
UDP-header source port: external sending-port number “c1” for its terminal 3
Data: session IDs “s1” and “s2,” as well as voice data in P3

Having received the packet P4, the caller terminal 1a searches the first session table based on the session IDs “s1” and “s2,” and recognizes that it is a packet from the receiver terminal 1b, relayed by the gateway 3.

(3-5) Effects

Though a plurality of communications are allocated to common ports on the firewalls 4a, 4b utilizing this relay method the gateway 3 may administer each communication according to session IDs patched to each telephone call unit. Improvement in security and facilitation of maintenance are accordingly anticipated. Allocating to every communication session IDs unique respectively to all caller terminals 1a, receiver terminals 1b, and gateways 3 enables interconnection with multi-stage communications relaying or a different kind of relaying technology.

### Routine for Calling

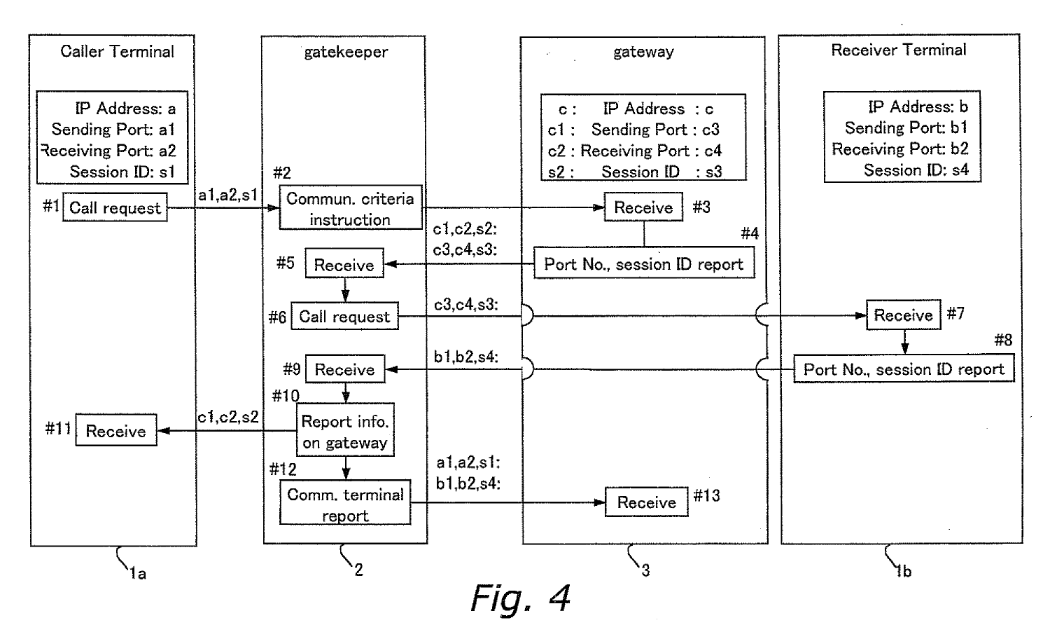

FIG. 4 is an explanatory diagram illustrating flow in a routine for calling. The sending-port numbers, receiving-port numbers, and session IDs are determined in this routine. In gross divisions this routine may be separated into the steps: (1) request from caller terminal 1a and session ID notification; (2) determination of gateway 3 session number; (3) determination of receiver-terminal 1b session ID; and (4) reporting session IDs to the caller terminal 1a and gateway 3. Below, each step will be explained in turn.

(1) Call Request from Caller Terminal 1a and Session ID Notification

First, a call request from the caller terminal 1a is made to the gatekeeper 2 (#1). Prior to transmitting the request, the caller terminal 1a determines the sending port “a1,” receiving port “a2,” and session ID “s1,” used in communicating with the receiver terminal 1b. This information is reported to the gatekeeper 2 together with the given call request.

(2) Determination of Gateway 3 Session Number The gatekeeper 2 receives the given call request and transmits an instruction on communications preparation to the gateway 3 (#2). The gatekeeper 2 reports to the gateway 3 the aforementioned IP address “a,” sending port “a1,” receiving port “a2,” and session ID “s1” for the caller terminal 1a, together with this instruction. The gateway 3 receives the given instruction and these items of information (#3), and determines the port number and session ID for its terminal. Namely, the gateway 3 determines the external session ID “s2,” external sending-port number “c1,” external receiving-port number “c2,” internal session ID “s3,” internal sending-port number “c3,” and internal receiving-port number “c4.” Subsequently, the gateway 3 reports the “c1,” “c2,” “s2,” “c3,” “c4” and “s3” information to the gatekeeper 2 (#4). The gatekeeper 2 receives the external and internal port numbers and session IDs for the gateway 3 and stores them in the fourth session table (#5).

### (3) Determination of Receiver-Terminal 1b Session ID

Furthermore, the gatekeeper 2 transmits the call request to the receiver terminal 1b (#6). Together with this request, the gatekeeper 2 reports the internal port numbers and the session ID for the gateway 3 to the receiver terminal 1b (#7). Namely, it reports the internal sending-port number “c3,” the internal receiving-port number “c4,” and the internal session ID “s3.” The receiver terminal 1b receives these, and determines its terminal port numbers “b1,” “b2,” and session ID “s4.” Subsequently, the receiver terminal 1b reports the determined port numbers and session ID to the gatekeeper 2 (#8).

### (4) Reporting Session IDs to the Caller Terminal 1a and Gateway 3

The gatekeeper 2 receives communication information for the given receiver terminal 1b (#9), and reports to the caller terminal 1a the external port numbers and session ID for the gateway 3 (#10). Namely, the gatekeeper 2 reports the external sending-port number “c1,” external receiving-port number “c2,” and external session ID “s2” to the caller terminal 1a. Having accepted these the caller terminal 1a from then on carries out communications using session IDs “s1” and “s2” with respect to the internal receiving-port number “c2” for the gateway 3 (#11).

Meanwhile, the gatekeeper 2 reports to the gateway 3 the aforementioned external information and internal information (#12). Namely, the gatekeeper 2 reports the sending-port number “a1,” receiving-port number “a2” and session ID “s1” for the caller terminal 1a, and the sending-port number “b1,” receiving-port number “b2” and session ID “s4” for the receiver terminal 1b to the gateway 3. Having gotten these the gateway 3 writes the received information into the third session table (#13). The gateway 3 from then on carries out, based on the third session table, relaying of voice telephone call between the caller terminal 1a and the receiver terminal 1b.

### Routine for Terminating Communications

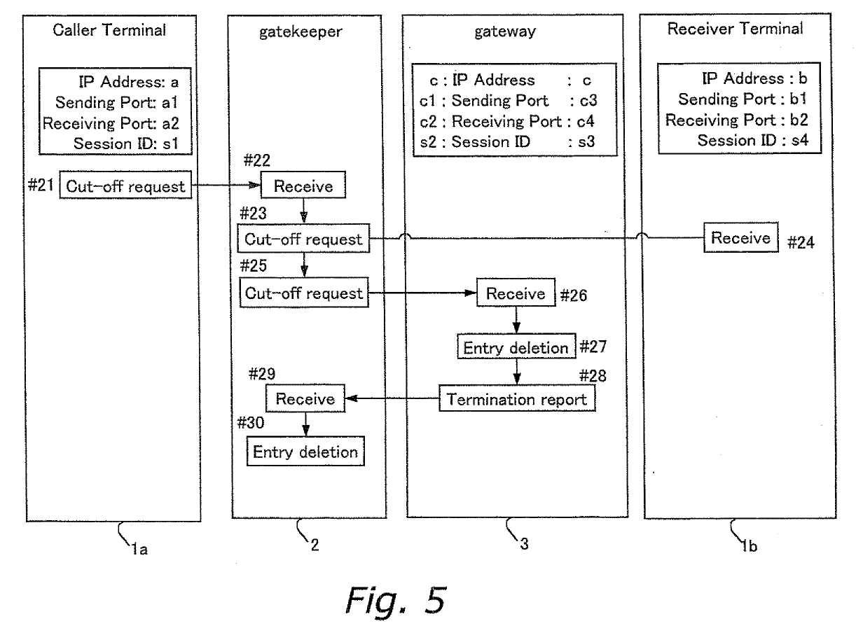

FIG. 5 is an explanatory diagram illustrating flow in a routine for terminating communications. Where a voice telephone call between the caller terminal 1a and receiver terminal 1b is to be terminated, the following routine is carried out. Here, in this situation, for ease of illustration the case of a cut-off request from the caller terminal 1a side will be explained, but a similar routine is carried out also when there is a cut-off request from the receiver terminal 1b. In gross divisions this routine classifies into two steps: (1) cut-off for the caller terminal 1a and receiver terminal 1b; and (2) cut-off process for the gatekeeper 2 and gateway 3.

### (1) Cut-off for the Caller Terminal 1a and Receiver Terminal 1b

First, the caller terminal 1a transmits a cut-off request to the gatekeeper 2 (#21). This request is transmitted utilizing a TCP connection established for administrating voice communications held with the gatekeeper 2. Therefore, the voice communication that should be cut off from the TCP connection may be deliberately determined. Having accepted this gatekeeper 2 transmits the cut-off request to the receiver terminal 1b through a corresponding administration channel (#22, #23, #24). The receiver terminal 1b thereby recognizes the communication termination.

### (2) Cut-Off Process for the Gatekeeper 2 and Gateway 3

Furthermore, the gatekeeper 2 transmits the cut-off request together with the session IDs “s1” and “s2” to the gateway 3 (#25, #26). The gateway 3 searches the third session table with, as keys, the session IDS contained in the cut-off request as keys. Further, the gateway 3 deletes from the third session table the entries hit resulting from the search (#27). Subsequently, the gateway 3 transmits a termination report to the gatekeeper 2 (#28). Having gotten this the gatekeeper 2 likewise searches the fourth session table on the session IDs as a key, and deletes the hit entries (#30). The telephone call by the caller terminal 1a and the receiver terminal 1b is thereby terminated.

### Other Routines

Here, in a situation in which the gateway 3 and gatekeeper 2 are used in communications control, breakdown of one of the devices conceivable. In order to cope with this, the gateway 3 and the gatekeeper 2 may establish a continual control connection, and an exchange of “keep alive” messages may be made at all times. If response from either to the keep-alive should cease for more than a fixed period, the devices may perform a process as follows.

First, if the gatekeeper 2 detects that the gateway 3 is down, a telephone-call cutoff report is made to the caller terminal 1a and receiver terminal 1b. Furthermore, the gatekeeper 2 sequentially deletes from the entries in the fourth session table the telephone call entry for the transmitted cutoff report.

Meanwhile, if the gateway 3 detects that the gatekeeper 2 is down, it deletes all the information in the third session table, and suspends packet rewriting.

The foregoing routines, wherein VoIP terminals on the Internet and VoIP terminals on an Intranet are connected, while being that a plurality of communications are allocated to a common port, enable the communications to be distinguished, and improve security while maintaining voice quality. Because individual session IDs between the direct communications partner and, respectively, the caller terminal, relaying device and receiver terminal are utilized, this method is applicable to multi-stage communications relaying. Furthermore, the fact that each telephone call is specified by combining with a session ID facilitates voice communications among devices whose address information is indeterminate, as with telephone calls from devices having plural IP addresses.

### Other Embodied Examples

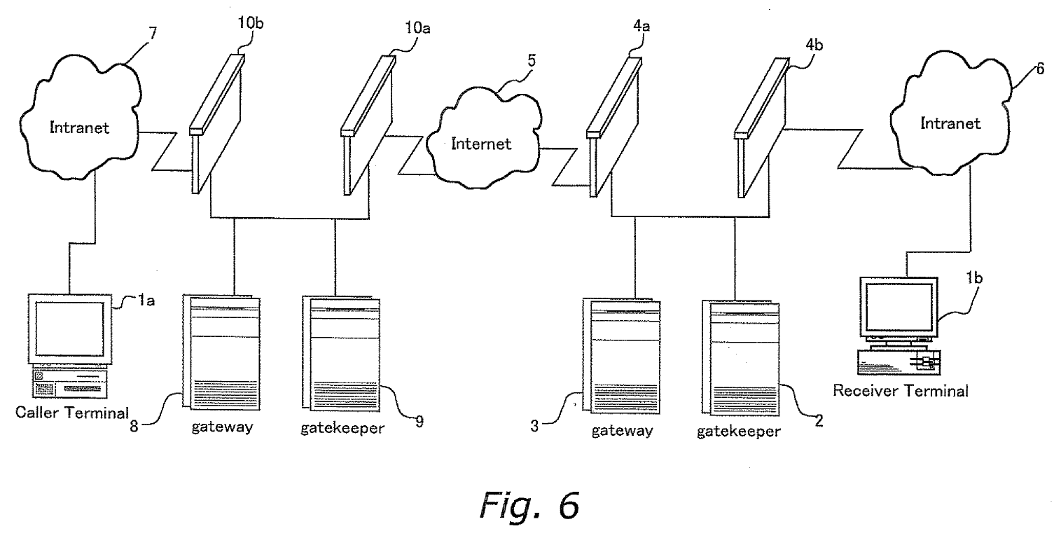

(A), FIG. 6 is an overall configurational diagram of communications control system having to do with a second embodied example. Caller terminal 1a is on an Intranet 7 in this system. Intranet 7 is connected to the Internet 5 via gateway 8 and gatekeeper 9. Firewalls 10a, 10b are constructed virtually between Intranet 7 and the Internet 5 by the gatekeeper 9. Elements indicated in the figure with the same reference marks as in the aforementioned FIG. 1 function likewise as the in first embodied example.

Routines that the caller terminal 1a, receiver terminal 1b, gatekeeper 2 and gateway 3 carry out in this system are likewise as in the foregoing first embodied example. Nevertheless, the communications partners for the caller terminal 1a are when calling, the gatekeeper 9, and after start of communications, the gateway 8. Further, communication partners for the gatekeeper 2 and gateway 3 become when calling, the gatekeeper 9, and after start of communications, the gateway 8.

The gateway 8 carries out the same routines as the foregoing gateway 3. Nevertheless, the gatekeeper 9 instead of the gatekeeper 2, the caller terminal 1a instead of the receiver terminal 1b, and the gateway 3 instead of the caller terminal 1a carry out communications. In other words, the gateway 8 negotiates with the gatekeeper 9 during a call, and relays communications between the caller terminal 1a and gateway 3 after start of communications.

The gatekeeper 9 carries out the same routines as the foregoing gatekeeper 2. Nevertheless, the gateway 3 instead of the gateway 8, and the receiver terminal 1b instead of the caller terminal 1a carry out communications.

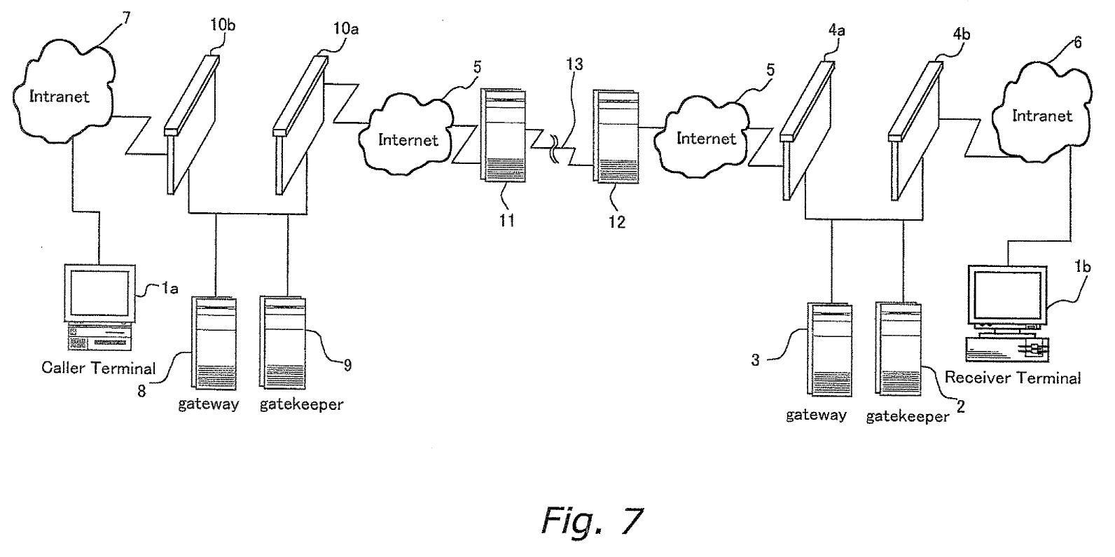

(B) FIG. 7 is an overall configurational diagram of communications control system having to do with a third embodied example. Elements indicated in the figure with the same reference marks as in the aforementioned FIG. 1 function likewise as the in first embodied example. Intranet 7 having the caller terminal 1a, and Intranet 6 having the receiver terminal 1b, are connected via communications terminals 11, 12 and network 13 in this system. In this way, though the caller terminal 1a and receiver terminal 1b are multi-stage connected via multiple communications terminals and a network, likewise as in the foregoing first embodied example, the terminals report session IDs mutually among one other. Because every terminal transmits/receives each other's session IDs together with data, a plurality of communications may be supported on one port.

(C) Programs for executing the foregoing method, and computer-readable recording media on which it is recorded are covered by the present invention. Flexible disks, hard disks, semiconductor memory, CD-ROMS, DVDs, magneto-optical disks (MOs) and other recording media for computer reading/writing may be cited.

Utilizing the present invention, while heightening communications security in an inside network connected to an outside network, enables support of a plurality of communications between the outside network and the inside network.

While only selected embodiments have been chosen to illustrate the present invention, to those skilled in the art it will be apparent from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

1. A communications control method utilized in a communications system in which a first communications terminal T1, a second communications terminal T2, and a relaying terminal that relays communications by the two terminals are connected via a network, the communications control method including:
a first determination step, prior to the first communications terminal T1 and the second communications terminal T2 carrying out communications via the relaying terminal, of the first communications terminal T1 determining first communications identification information S1 for identifying intercommunications between its terminal and the relaying terminal;
a second determination step, prior to the first communications terminal T1 and the second communications terminal T2 carrying out communications via the relaying terminal, of the relaying terminal determining second communications identification information S2 for identifying intercommunications between its terminal and the first communications terminal T1;
a third determination step, prior to the first communications terminal T1 and the second communications terminal T2 carrying out communications via the relaying terminal, of the relaying terminal determining third communications identification information S3 for identifying intercommunications between its terminal and the second communications terminal T2;
a fourth determination step, prior to the first communications terminal T1 and the second communications terminal T2 carrying out communications via the relaying terminal, of the second communications terminal T2 determining fourth communications identification information S4 for identifying intercommunications between its terminal and the relaying terminal;
a first communications step of the first communications terminal T1 and the relaying terminal carrying out transmission and reception of first data containing the first communications identification information S1 and the second communications identification information S2;
a second communications step of the second communications terminal T2 and the relaying terminal carrying out transmission and reception of second data containing the third communications identification information S3 and the fourth communications identification information S4;
a first relaying step, when the relaying terminal is to transmit to the second communications terminal T2 first data received from the first communications terminal T1, of rewriting within said first data the first communications identification information S1 and the second communications identification information S2 as the third communications identification information S3 and the fourth communications identification information S4; and
a second relaying step, when the relaying terminal is to transmit to the first communications terminal T1 data received from the second communications terminal T2, of rewriting within said data the third communications identification information S3 and the fourth communications identification information S4 as the first communications identification information S1 and the second communications identification information S2.

2. A relaying method utilized by a relaying terminal that is connected via a network with a first communications terminal T1 and a second communications terminal T2, and that relays communications between the two terminals, the relaying method including:
a first determination step of determining second communications identification information S2 identifying a communication carried out with the first communications terminal T1 for relaying communications between the first communications terminal T1 and the second communications terminal T2;
a second determination step of determining third communications identification information S3 for identifying a communication carried out with the second communications terminal T2 for relaying communications between the first communications terminal T1 and the second communications terminal T2;
a first communications step of carrying out with the first communications terminal T1 transmission and reception of data containing the second communications identification information S2;
a second communications step of carrying out with the second communications terminal T2 transmission and reception of data containing the third communications identification information S3;
a first relaying step of rewriting, when data received from the first communications terminal T1 is to be transmitted to the second communications terminal T2, the second communications identification information S2 within said data as the third communications identification information S3; and
a second relaying step of rewriting, when data received from the second communications terminal T2 is to be transmitted to the first communications terminal T1 the third communications identification S3 within said data as the second communications identification information S2.

3. The relaying method set forth in claim 2, further including:
a first acquisition step of acquiring first communications identification information S1 identifying a communication that the first communications terminal T1 carries out with the relaying terminal in order to communicate with the second communications terminal T2;
a second acquisition step of acquiring fourth communications identification information S4 identifying a communication that the second communications terminal T2 carries out with the relaying terminal in order to communicate with the first communications terminal T1; wherein
said first communications step carries out with the first communications terminal T1 transmission and reception of data further containing the first communications identification information S1,
said second communications step carries out with second communications terminal T2 transmission and reception of data further containing the fourth communications identification information S4,
said first relaying step, when data received from the first communications terminal T1 is to be transmitted to the second communications terminal T2, rewrites within said data the first communications identification information S1 and the second communications identification information S2 as the third communications identification information S3 and the fourth communications identification information S4, and
said second relaying step, when data received from the second communications terminal T2 is to be transmitted to the first communications terminal T1, rewrites within said data the third communications identification information S3 and the fourth communications identification information S4 as the first communications identification information S1 and the second communications identification information S2.

4. The relaying method set forth in claim 2, further including a table-preparation step of preparing a session table; wherein
within a single record the session table:
stores the first communications identification information S1 and second communications identification information S2 correlatively with a communications address for the first communications terminal T1, and
stores the third communications identification information S3 and the fourth communications identification information S4 correlatively with a communications address for the second communications terminal T2.

5. The relaying method set forth in claim 4, further including:
a termination receiving step of accepting notification that communications between the first communications terminal T1 and the second communications terminal T2 have terminated; and
a deletion step of deleting from the session table a record corresponding to communications between the first communications terminal T1 and the second communications terminal T2.

6. The relaying method set forth in claim 2, wherein the relaying terminal is further connected with a computer terminal connected via the network to the first communications terminal T1 and the second communications terminal T2, further including:
a communications-request receiving step of receiving from the computer terminal a report indicating that there has been a request from the first communications terminal T1 for communication with the second communications terminal T2;
a first notification step of reporting the second communications identification information S2 to the first communications terminal T1 via the computer terminal; and
a second notification step of reporting the third communications identification information S3 to the second communications terminal T2 via the computer terminal.

7. The relaying method set forth in claim 6, further including:
a third acquisition step of acquiring from the computer first communications identification information S1 identifying a communication that the first communications terminal T1 carries out with the relaying terminal in order to communicate with the second communications terminal T2;
a fourth acquisition step of acquiring from the computer fourth communications identification information S4 identifying a communication that the second communications terminal T2 carries out with the relaying terminal in order to communicate with the first communications terminal T1; wherein
said first communications step carries out with the first communications terminal T1 transmission and reception of data further containing the first communications identification information S1,
said second communications step carries out with second communications terminal T2 transmission and reception of data further containing the fourth communications identification information S4,
said first relaying step, when data received from the first communications terminal T1 is to be transmitted to the second communications terminal T2, rewrites within said data the first communications identification information S1 and the second communications identification information S2 as the third communications identification information S3 and the fourth communications identification information S4, and
said second relaying step, when data received from the second communications terminal T2 is to be transmitted to the first communications terminal T1, rewrites within said data the third communications identification information S3 and the fourth communications identification information S4 as the first communications identification information S1 and the second communications identification information S2.

8. The relaying method set forth in claim 6, further including:
an alive-confirmation step of transmitting to and receiving from the computer terminal at fixed time intervals TM1 alive information signifying one's terminal is alive; and
a suspend step of suspending relaying of communications between the first communications terminal T1 and the second communications terminal T2 if the alive information has not been received from the computer terminal though a fixed time TM2 or more has elapsed.

9. A relaying device connected via a network with a first communications terminal T1 and a second communications terminal T2, for relaying communications between the two terminals, the relaying device comprising:
a first determination means for determining second communications identification information S2 identifying a communication carried out with the first communications terminal T1 for relaying communications between the first communications terminal T1 and the second communications terminal T2;
a second determination means for determining third communications identification information S3 identifying a communication carried out with the second communications terminal T2 for relaying communications between the first communications terminal T1 and the second communications terminal T2;
a first communications means for carrying out with the first communications terminal T1 transmission and reception of data containing the second communications identification information S2;
a second communications means for carrying out with the second communications terminal T2 transmission and reception of data containing the third communications identification information S3;
a first relaying means for rewriting, when data received from the first communications terminal T1 is to be transmitted to the second communications terminal T2, the second communications identification information S2 within said data as the third communications identification information S3; and
a second relaying means for rewriting, when data received from the second communications terminal T2 is to be transmitted to the first communications terminal T1, the third communications identification S3 within said data as the second communications identification information S2.

10. A relaying computer product utilized by a computer connected via a network with a first communications terminal T1 and a second communications terminal T2, for relaying communications between the two terminals, the relaying computer product for making the computer function as:
a first determination means for determining second communications identification information S2 identifying a communication carried out with the first communications terminal T1 for relaying communications between the first communications terminal T1 and the second communications terminal T2;
a second determination means for determining third communications identification information S3 identifying a communication carried out with the second communications terminal T2 for relaying communications between the first communications terminal T1 and the second communications terminal T2;
a first communications means for carrying out with the first communications terminal T1 transmission and reception of data containing the second communications identification information S2;
a second communications means for carrying out with the second communications terminal T2 transmission and reception of data containing the third communications identification information S3;
a first relaying means for rewriting, when data received from the first communications terminal T1 is to be transmitted to the second communications terminal T2, the second communications identification information S2 within said data as the third communications identification information S3; and
a second relaying means for rewriting, when data received from the second communications terminal T2 is to be transmitted to the first communications terminal T1, the third communications identification S3 within said data as the second communications identification information S2.

11. A computer-readable recording medium on which is recorded a relaying program utilized by a relaying terminal that is connected via a network with a first communications terminal T1 and a second communications terminal T2, and that relays communications between the two terminals, the computer-readable recording medium on which is recorded a relaying program for executing:
a first determination step of determining second communications identification information S2 identifying a communication carried out with the first communications terminal T1 for relaying communications between the first communications terminal T1 and the second communications terminal T2;
a second determination step of determining third communications identification information S3 for identifying a communication carried out with the second communications terminal T2 for relaying communications by the first communications terminal T1 and the second communications terminal T2;
a first communications step of carrying out with the first communications terminal T1 transmission and reception of data containing the second communications identification information S2;
a second communications step of carrying out with the second communications terminal T2 transmission and reception of data containing the third communications identification information S3;
a first relaying step of rewriting, when data received from the first communications terminal T1 is to be transmitted to the second communications terminal T2, the second communications identification information S2 within said data as the third communications identification information S3; and
a second relaying step of rewriting, when data received from the second communications terminal T2 is to be transmitted to the first communications terminal T1, the third communications identification S3 within said data as the second communications identification information S2.

12-23. (canceled)
